(19) United States
(12) Patent Application Publication
(10) Pub. No.: US 2020/0378286 A1
(43) Pub. Date: Dec. 3, 2020

(54) PASSIVE NITROGEN OXIDE ADSORBER

(71) Applicant: UMICORE AG & CO. KG, Hanau-Wolfgang (DE)

(72) Inventors: Christoph HENGST, Butzbach (DE); Gordon KEITL, Frankfurt (DE); Michael LENNARTZ, Frankfurt (DE)

(73) Assignee: UMICORE AG & CO. KG, Hanau-Wolfgang (DE)

(21) Appl. No.: 16/959,733

(22) PCT Filed: Jan. 4, 2019
(86) PCT No.: PCT/EP2019/050142

§ 371 Date: Jul. 2, 2020

(30) Foreign Application Priority Data
Jan. 5, 2018 (EP) 18150393.9

(51) Int. Cl. F01N 3/08; F01N 3/20; B01J 37/02; B01J 29/068; B01J 29/04

(52) U.S. Cl. CPC F01N 3/0814; F01N 3/2066; B01J 29/043; B01J 29/068; B01J 37/0246; B01J 37/0244

(57) ABSTRACT

The present invention relates to a catalyst, comprising a carrier substrate of the length (L) which extends between two carrier substrate ends (a and b) and has two coating zones (A and B), wherein the coating zone (A) comprises a zeolite and palladium and, proceeding from the carrier substrate end (a), extends on a part of the length (L), the coating zone (B) comprises the same components as coating zone (A) and platinum and, proceeding from the carrier substrate end (b), extends on a part of the length (L), wherein L=L_{A}+L_{B}, wherein LA denotes the length of the coating zone (A) and L_{B} denotes the length of the coating zone (B). The invention also relates to an exhaust system containing said catalyst.

The present invention relates to a passive nitrogen oxide adsorber for the passive storage of nitrogen oxides from the exhaust gas of a combustion engine, which comprises zeolite, palladium and platinum.

The exhaust gas of motor vehicles that are operated with lean-burn combustion engines, such as diesel engines, also contain, in addition to carbon monoxide (CO) and nitrogen oxides (NOₓ), components that result from the incomplete combustion of the fuel in the combustion chamber of the cylinder. In addition to residual hydrocarbons (HC), most of which are also gaseous, these include particulate emissions, which are also referred to as “diesel soot” or “soot particles.” These are complex agglomerates from predominantly carbonaceous particulate matter and an adhering liquid phase, which usually predominantly consists of longer-chained hydrocarbon condensates. The liquid phase adhering to the solid components is also referred to as “Soluble Organic Fraction SOF” or “Volatile Organic Fraction VOF.”

In order to clean such exhaust gases, the specified components must be converted as completely as possible into harmless compounds, which is only possible by using suitable catalysts.

Soot particles may be very effectively removed from the exhaust gas with the aid of particle filters. Wall-flow filters made of ceramic materials have proved particularly successful. These are made up of a multiple number of parallel channels formed by porous walls. The channels are closed alternately at one end of the filter, such that first channels are formed, which are open at the first side of the filter and closed at the second side of the filter, along with second channels, which are closed at the first side of the filter and open at the second side of the filter. The exhaust gas flowing into the first channels, for example, may leave the filter again only via the second channels and must flow through the porous walls between the first and second channels for this purpose. The particles are retained when the exhaust gas passes through the wall. It is known that particle filters can be provided with catalytically active coatings. For example, EP1820561 A1 describes the coating of a diesel particle filter with a catalyst layer that facilitates the combustion of the filtered soot particles.

A well-known process for removing nitrogen oxides from exhaust gases in the presence of oxygen is selective catalytic reduction using ammonia on a suitable catalyst (SCR process). With this process, the nitrogen oxides to be removed from the exhaust gas are converted into nitrogen and water using ammonia as a reducing agent.

As SCR catalysts, for example, iron-exchanged and particularly copper-exchanged zeolites can be used; see for example WO2008/106519 A1, WO2008/118434 A1 and WO2008/132452 A2. SCR catalysts for the conversion of nitrogen oxides with ammonia do not contain any precious metals, in particular no platinum and no palladium. In the presence of such metals, the oxidation of ammonia with oxygen into nitrogen oxides would be preferred, and the SCR reaction (conversion of ammonia with nitrogen oxide) would fall into second place. Where the literature sometimes speaks of platinum-exchanged or palladium-exchanged zeolites as “SCR catalysts,” this does not refer to the NH₃ SCR reaction but to the reduction of nitrogen oxides by means of hydrocarbons. However, the latter conversion is not very selective and is therefore referred to as the “HC-DeNOx reaction” instead of the “SCR reaction.” The ammonia used as reducing agent can be made available by metering an ammonia precursor compound, such as urea, ammonium carbamate or ammonium formate, into the exhaust tract and subsequent hydrolysis. SCR catalysts have the disadvantage that they only work above an exhaust gas temperature of approximately 180 to 200° C., and thus do not convert nitrogen oxides, which are formed in the cold-start phase of the engine.

So-called “nitrogen oxide storage catalysts,” for which the term “lean NOx trap” or “LNT” is also commonly used, are also known for removing nitrogen oxides from the exhaust gas. Their cleaning action is based upon the fact that, in a lean operating phase of the engine, the nitrogen oxides are predominantly stored in the form of nitrates by the storage material of the storage catalyst, and the nitrates are broken down again in a subsequent rich operating phase of the engine, and the nitrogen oxides which are thereby released are converted with the reducing exhaust gas components in the storage catalyst to nitrogen, carbon dioxide, and water. This operating principle is described in, for example, SAE document SAE 950809. As storage materials, oxides, carbonates, or hydroxides of magnesium, calcium, strontium, barium, alkali metals, rare earth metals, or mixtures thereof come, in particular, into consideration. Due to their basic properties, such compounds are able to form nitrates with the acidic nitrogen oxides of the exhaust gas and store them in this manner. They are deposited with the highest possible dispersion on suitable carrier materials in order to generate a large interaction surface with the exhaust gas. As a rule, nitrogen oxide storage catalysts also contain precious metals such as platinum, palladium and/or rhodium as catalytically active components. Their task is, on the one hand, to oxidize NO into NO₂, CO and HC into CO₂ and H₂O under lean conditions, and, on the other hand, to reduce released NO₂ into nitrogen during the rich operating phases, in which the nitrogen oxide storage catalyst is regenerated. Modern nitrogen oxide storage catalysts are described, for example, in EP0885650 A2, US2009/320457, WO2012/029050 A1 and WO2016/020351 A1.

It is already known to combine soot particle filters and nitrogen oxide storage catalysts. For example, EP1420 149 A2 and US2008/141661 describe systems comprising a diesel particle filter and a nitrogen oxide storage catalyst arranged downstream.

Moreover, it has already been proposed in, for example, EP1393069 A2, EP1433519 A1, EP2505803 A2, and US2014/322112, to coat particle filters with nitrogen oxide storage catalysts, US2014/322112 describes a zoning of the coating of the particle filter with nitrogen oxide storage catalyst in such a way that a zone starting from the upstream end of the particle filter is located in the input channels, and another zone starting from the downstream end of the particle filter is located in the output channels. The procedure described in SAE Technical Paper 950809, in which the nitrogen oxides are stored by a nitrogen oxide storage catalyst in a lean-burn operating phase of the engine and are released again in a subsequent rich operating phase, is also referred to as active nitrogen oxide storage,

In addition, a method known as passive nitrogen oxide storage has also been described. Here nitrogen oxides are stored in a first temperature range and released again in a second temperature range, wherein the second temperature range is at higher temperatures than the first temperature range. Passive nitrogen oxide storage catalysts are used to implement this method, which catalysts are also referred to as PNA (for “passive NOx adsorbers”). Passive nitrogen oxide storage catalysts can be used to store and release nitrogen oxides, particularly at temperatures below 200° C., at which an SCR catalyst has not yet reached its operating temperature, as soon as the SCR catalyst is ready for operation. Through the intermediate storage of the nitrogen oxides emitted by the engine below 200° C. and their concerted release above 200° C., an increased total nitrogen oxide conversion of the exhaust gas aftertreatment system can be realized.

Palladium supported on cerium oxide has been described as a passive nitrogen oxide storage catalyst; see for example WO2008/047170 A1 and WO2014/184568 A1, which can also be coated on a particle filter according to WO2012/071421 A2 and WO2012/156883 A1. It is known from WO2012/166868 A1 for a zeolite containing palladium and another metal such as iron to be used as a passive nitrogen oxide storage catalyst. WO2015/085303 A1 discloses passive nitrogen oxide storage catalysts which contain a precious metal and a small-pore molecular sieve with a maximum ring size of eight tetrahedral atoms.

Modern and future diesel engines are becoming ever more efficient, which also lowers exhaust gas temperatures. In parallel, the legislation on the conversion of nitrogen oxides is becoming increasingly stringent. This results in the fact that SCR catalysts alone no longer suffice for compliance with the nitrogen oxide limits. In particular, there continues to be further need for technical solutions that ensure that nitrogen oxides formed during the engine's cold-start phase do not escape into the environment. In addition, technical solutions must ensure that stored nitrogen oxides are released (desorbed) as completely as possible in the operating window of a downstream SCR catalyst.

It has now been found that zeolites coated with palladium, which additionally comprise platinum in a partial region, have excellent passive nitrogen-oxide adsorption properties.

The present invention accordingly relates to a catalyst which comprises a carrier substrate of length L, which extends between two carrier substrate ends a and b and comprises two coating zones A and B, wherein coating zone A comprises a zeolite and palladium and extends from carrier substrate end a along a part of length L, coating zone B comprises the same components as coating zone A and platinum and extends starting from carrier substrate end b along a part of length L, wherein L=L_{A}+L_{B} applies, wherein L_{A} is the length of the coating zone A and L_{B} is the length of the coating zone B.

The feature, according to which coating zone A extends from carrier substrate end a along a part of length L, means that length L_{A} is >0. Similarly, the feature according to which coating zone B extends from carrier substrate end b along a part of length L means that length L_{B} is >0. In embodiments of the present invention, coating zone A extends from carrier substrate end a to 20 to 80%, preferably 40 to 60%, of length L. Accordingly, coating zone B also extends from carrier substrate end b to 20 to 80%, preferably 40 to 60%, of length L.

Zeolites are two- or three-dimensional structures, the smallest structures of which can be regarded as SiO₄ and AlO₄ tetrahedra. These tetrahedra come together to form larger structures, wherein two are connected each time via a common oxygen atom. Rings of different sizes can be formed, for example rings of four, six or even nine tetrahedrally coordinated silicon or aluminum atoms. The various zeolite types are often defined by the largest ring size, because such size determines which guest molecules can and cannot penetrate the zeolite structure. It is customary to differentiate between large-pore zeolites with a maximum ring size of 12, medium-pore zeolites with a maximum ring size of 10, and small-pore zeolites with a maximum ring size of 8. Zeolites are further divided into structure types by the Structural Commission of the International Zeolite Association, each of which is assigned a three-letter code; see for example Atlas of Zeolite Framework Types, Elsevier, 5th edition, 2001.

The catalyst according to the invention comprises a zeolite, which can be large-pored, medium-pored or small-pored.

In one embodiment, the catalyst according to the invention comprises a zeolite, the largest channels of which are formed by 6 tetrahedrally coordinated atoms and which, for example, belongs to the structure types AFG, AST, DOH, FAR, FRA, GIU, LIO, LOS, MAR, MEP, MSO, MTN, NON, RUT, SGT, SOD, SW, TOL or UOZ. A zeolite of structure type AFG is afghanite. Zeolites of structure type AST are AlPO 16 and octadecasil. A zeolite of structure type DOH is docecasil 1H, A zeolite of structure type FAR is farneseite. A zeolite of structure type FRA is franzinite. A zeolite of structure type GIU is giuseppettite. A zeolite of structure type LIO is liottite. Zeolites of structure type LOS are losod and bystrite. A zeolite of structure type MAR is marinellite. A zeolite of structure type MEP is melanophlogite. Zeolites of structure type MSO are MCM-61 and Mu-13. Zeolites of structure type MTN are ZSM-39, CF-4, docecasil-3C and holdstite. Zeolites of structure type NON are nonasil, CF-3 and ZSM-51. Zeolites of structure type RUT are RUB-10 and Nu-1. A zeolite of structure type SGT is sigma-2. Zeolites of structure type SOD are sodalite, AlPO-20, bicchulite, danalite, G, genthelvite, hauyn, herlvine, noselite, SIZ-9, TMA and tugtupite. A zeolite of structure type UOZ is IM-10. The catalyst according to the invention preferably comprises a zeolite, the largest channels of which are formed by 6 tetrahedrally coordinated atoms and which belongs to structure type SOD. Particularly suitable zeolites belonging to structure type SOD are well-known in the literature, For example, the synthesis of AlPO-20 is described in U.S. Pat. No. 4,310,440.

In another embodiment, the catalyst according to the invention comprises a zeolite, the largest channels of which are formed by 8 tetrahedrally coordinated atoms and which has the structure types ABW, ACO, AEI, AEN, AFN, AFT, AFV, AFX, ANA, APC, APD, ATN, ATT, ATV, AVL, AWO, AW, BCT, BIK, BRE, CAS, CDO, CHA, DDR, DFT, EAB, EDI, EEI, EPI, ERI, ESV, ETL, GIS, GOO, IFY, IHW, IRN, ITE, ITW, JBW, JNT, JOZ, JSN, JSW, KFI, LEV, -LIT, LTA, LTJ, LIN, MER, MON, MTF, MWF, NPT, NSI, OWE, PAU, PHI, RHO, RTH, RWR, SAS, SAT, SAV, SBN, SIV, THO, TSC, UEI, UFI, VNI, YUG or ZON. A zeolite of structure type ABW is Li-A. A zeolite of structure type ACO is ACP-1. Zeolites of structure type AEI are SAP0-18, SIZ-8 and SSZ-39. Zeolites of structure type AEN are AlPO-53, IST-2, JDF-2, MCS-1, Mu-10 and Ui0-12-500. A zeolite of structure type AFT is AlPO-52. Zeolites of structure type AFX are SAPO-56 and SSZ-16. Zeolites of structure type ANA are analcime, AlPO-24, leucite, Na—B, pollucite and wairakite. Zeolites of structure type APC are AlPO-C and AlPO-H1 Zeolites of structure type APD are AlPO-D and APO-CJ3. Zeolites of structure type ATN are MAPO-39 and SAPO-39. Zeolites of structure type ATT are AlPO-33 and RMA-3. A zeolite of structure type ATV is AlPO-25. A zeolite of structure type AWO is AlPO-21. A zeolite of structure type AWW is AlPO-22. Zeolites of structure type BCT are metavariscite and svyatoslavite. A zeolite of structure type BIK is bikitaite. Zeolites of structure type BRE are brewsterite and CIT-4, A zeolite of structure type CAS is EU-20b. Zeolites of structure type CDO are CDS-1, MCM-65 and UZM-25. Zeolites of structure type CHA are AlPO-34, chabazite, DAF-5, linde-D, linde-R, LZ-218, phi, SAPO-34, SAPO-47, SSZ-13, UiO-21, willhendersonite, ZK-14 and ZYT-6. Zeolites of structure type DDR are sigma-1 and ZSM-58. Zeolites of structure type DFT are DAF-2 and ACP-3. Zeolites of structure type EAB are TMA-E and belluphite. Zeolites of structure type EDI are edingtonite, K-F, linde F and zeolite N. Zeolites of structure type ERI are erionite, AlPO-17, linde T, LZ-220, SAPO-17 and ZSM-34. A zeolite of structure type ESV is ERS-7. Zeolites of structure type GIS are gismondine, amicite, garronite, gobbinsite, MAPO-43, Na-P1, Na-P2 and SAPO-43. A zeolite of structure type IHW is ITQ-3. Zeolites of structure type ITE are ITQ-3, Mu-14 and SSZ-36. A zeolite of structure type ITW is ITQ-12. Zeolites of structure type JBW are Na-J and nepheline. Zeolites of structure type KFI are ZK-5, P and Q. Zeolites of structure type LEV are levyne, levynite, AIP-35, LZ-132, NU-3, SAPO-35 and ZK-20. A zeolite of structure type-LIT is lithosite. Zeolites of structure type LTA are linde type A, alpha, ITQ-29, LZ-215, N-A, UZM-9, SAPO-42, ZK-21, ZK-22 and ZK-4. Zeolites of structure type LTN are linde type N and NaZ-21. Zeolites of structure type MER are meriinoite, K-M, linde W and zeolite W. Zeolites of structure type MTF are MCM-35 and UTM-1. Zeolites of structure type NSI are Nu-6(2) and EU-20. Zeolites of structure type OWE are UiO-28 and ACP-2. Zeolites of structure type PAU are paulingite and ECR-18. Zeolites of structure type PHI are philippsite, DAF-8, harmotorne, wellsite and ZK-19. Zeolites of structure type RHO are rho and LZ-214. Zeolites of structure type RTH are RUB-13, SSZ-36 and SSZ-50. A zeolite of structure type RWR is RUB-24. Zeolites of structure type SAS are STA-6 and SSZ-73. A zeolite of structure type SAT is STA-2. Zeolites of structure type SBN are UCSB-89 and SU-46. A zeolite of structure type SIV is SIZ-7. A zeolite of structure type THO is thomsonite. A zeolite of structure type UEI is Mu-18. A zeolite of structure type UFI is UZM-5. A zeolite of structure type VNI is VPI-9. Zeolites of structure type YUG are yugawaralite and Sr-Q. Zeolites of structure type ZON are ZAPO-M1 and UiO-7. The catalyst according to the invention preferably comprises a zeolite, the largest channels of which are formed by 8 tetrahedrally coordinated atoms and which belongs to the structure type ABW, AEI, AFX, CHA, ERI, ESV, KFI, LEV or LTA. The synthesis of zeolites of structure type AEI is described for example in US 2015/118150, that of SSZ-39 in U.S. Pat. No. 5,958,370. Zeolites of structure type AFX are known from WO 2016/077667 A1. Zeolites of structure type CHA are described extensively in the literature; see for example U.S. Pat. No. 4,544,538 for SSZ-13. ZK-5, which belongs to structure type KFI, is described, for example, in EP 288293 A2. Zeolites of structure type LEV are described, for example, in EP 40016 A1, EP 255770A2 and EP 3009400A1. Zeolites belonging to structure type LTA are known, for example, as SAPO-42, ZK-4, ZK-21 and ZK-22. For example, the synthesis of ZK-4 is described by Leiggener et al. in Material Syntheses, Springer Vienna, 2008 (editors, Schubert, Hüsing, Leine), pages 21-28). ZK-21 is described in U.S. Pat. No. 3,355,246 and SAPO-42 is described in US20141170062.

In another embodiment, the catalyst according to the invention comprises a zeolite, the largest channels of which are formed by 9 tetrahedrally coordinated atoms and which belongs, for example, to structure types -CHI, LOV, NAB, NAT, RSN, STT or VSV. A zeolite of structure type -CHI is chiavennite. A zeolite of structure type LOV is lovdarite. A zeolite of structure type NAB is nabesite. Zeolites of structure type NAT are natrolite, gonnardite, mesolite, metanatrolite, paranatrolite, tetranatrolite and scolecite. A zeolite of structure type RSN is RUB-17. A zeolite of structure type STT is SSZ-23. Zeolites of structure type VSV are gaultite, VPI-7 and VSV-7. The catalyst according to the invention preferably comprises a zeolite, the largest channels of which are formed by 9 tetrahedrally coordinated atoms and which belongs to structure type STT. A particularly suitable zeolite of structure type STT is SSZ-23. SSZ-23 is described in U.S. Pat. No. 4,859,442 and can be obtained according to the manufacturing processes specified therein.

In another embodiment, the catalyst according to the invention comprises a zeolite, the largest channels of which are formed by 10 tetrahedrally coordinated atoms and which, for example, belongs to structure types FER, MEL, MFI, MTT, MWW or SZR. Zeolites belonging to structure type FER are well-known in the literature. For example, ZSM-35 is described in U.S. Pat. No. 4,107,196, NU-23 in EP 103981 A1, FU-9 in EP 55529 A1, ISI-6 in U.S. Pat. No. 4,695,440 and ferrierite, for example, in U.S. Pat. No. 3,933,974, 4,000,248 and 4,251,499. Zeolites belonging to structure type MEL are well-known in the literature. For example, ZSM-11 is described in Nature 275, 119-120, 1978, SSZ-46 is described in U.S. Pat. No. 5,968,474 and TS-2 is described in BE 1001038. Zeolites belonging to structure type MTT are well-known in the literature. For example, ZSM-23 is described in U.S. Pat. No. 4,076,842, EU-13 is described in U.S. Pat. No. 4,705,674 and ISI-4 is described in U.S. Pat. Nos. 4,657,750, 5,314,674 also deals with the synthesis of zeolites of structure type MTT. Zeolites belonging to structure type MFI are known in the literature under the names ZSM-5, ZS-4, AZ-1, FZ-1, LZ-105, NU-4, NU-5, TS-1, TS, USC-4 and ZBH, for example. For example, ZSM-5 is described in U.S. Pat. Nos. 3,702,886 and 4,139,600. Zeolites belonging to structure type MWW are known in the literature. Thus, SSZ-25 is described in U.S. Pat. No. 4,826,667, MCM-22 in Zeolites 15, Issue 1, 2-8, 1995, ITQ-1 in U.S. Pat. No. 6,077,498 and PSH-3 in U.S. Pat. No. 4,439,409. Zeolites belonging to structure type SZR are well-known in the literature. For example, SUZ-4 is described in J. Chem. Soc., Chem. Commun., 1993, 894-896. The catalyst according to the invention preferably comprises a zeolite, the largest channels of which are formed by 10 tetrahedrally coordinated atoms and which belongs to structure type FER.

In another embodiment, the catalyst according to the invention comprises a zeolite, the largest channels of which are formed by 12 tetrahedrally coordinated atoms and which, for example, belongs to structure types AFI, AFR, AFS, AFY, ASV, ATO, ATS, BEA, BEC, BOG, BPH, CAN, CON, CZP, DFO, EMT, EON, EZT, FAU, GME, GON, IFR, ISV, IWR, IWV, IWW, LTL, MAZ, MEI, MOR, MOZ, MSE, MTW, NPO, OFF, OSI, -RON, RWY, SAO, SBE, SBS, SBT, SFE, SFO, SOS, SSY, USI or VET. Zeolites of structure type AFI are AlPO-5, SSZ-24 and SAPO-5. Zeolites of structure type AFR are SAPO-40 and AlPO-40. A zeolite of structure type AFS is MAPO-46. A zeolite of structure type ASV is ASU-7. Zeolites of structure type ATO are SAPO-31 and AlPO-31. Zeolites of structure type ATS are SSZ-55 and AlPO-36. Zeolites of structure type BEA are beta and CIT-6. Zeolites of structure type BPH are linde Q, STA-5 and UZM-4. Zeolites of structure type CAN are ECR-5, davyn, microsommite, tiptopite and vishnevite. Zeolites of structure type CON are CIT-1, SS-26 and SSZ-33. A zeolite of structure type DFO is DAF-1. Zeolites of structure type EMT are EMC-2, CSZ-1, ECR-30, ZSM-20 and ZSM-3. Zeolites of structure type EON are ECR-1 and TUN-7. A zeolite of structure type EZT is EMM-3. Zeolites of structure type FAU are faujasite, LZ-210, SAPO-37, CSZ-1, ECR-30, ZSM-20 and ZSM-3. A zeolite of structure type GME is gmelinite. A zeolite of structure type GON is GUS-1. Zeolites of structure type IFR are ITQ-4, MCM-58 and SSZ-42. A zeolite of structure type ISV is ITQ-7. A zeolite of structure type NUR is ITO-24. A zeolite of structure type IWV is ITQ-27. A zeolite of structure type IWW is ITQ-22. Zeolites of structure type LTL are linde type L and LZ-212. Zeolites of structure type MAZ are mazzite, LZ-202, omega and ZSM-4. Zeolites of structure type MEI are ZSM-18 and ECR-40. Zeolites of structure type MOR are mordenite, LZ-211 and Na-D. A zeolite of structure type MOZ is ZSM-10. A zeolite of structure type MSE is MCM-68. Zeolites of structure type MTW are ZSM-12, CZH-5, NU-13, TPZ-12, theta-3 and VS-12. Zeolites of structure type OFF are offretite, LZ-217, linde T and TMA-O. A zeolite of structure type OSI is UiO-6. A zeolite of structure type RWY is UCR-20. A zeolite of structure type SAO is STA-1. A zeolite of structure type SFE is SSZ-48. A zeolite of structure type SFO is SSZ-51. Zeolites of structure type SOS are SU-16 and FJ-17. A zeolite of structure type SSY is SSZ-60. A zeolite of structure type USI is IM-6. A zeolite of structure type VET is VPI-8. The catalyst according to the invention preferably includes a zeolite, the largest channels of which are formed by 12 tetrahedrally coordinated atoms and which belongs to structure type BEA or FAU. Zeolites of structure types BEA and FAU along with their production are described in detail in the literature.

The catalyst according to the invention more particularly preferably comprises a zeolite of structure type ABW, AEI, AFX, BEA, CHA, ERI, ESV, FAU, FER, KFI, LEV, LTA, MFI, SOD or SIT. The catalyst according to the invention comprises palladium. Both are preferably present as cations in the zeolite structure, i.e. in ion-exchanged form. However, they may also be wholly or partly present as metal and/or oxide in the zeolite structure and/or on the surface of the zeolite structure.

Palladium is preferably present in amounts 010.01 to 10% by weight, particularly preferably from 1.5 to 10% by weight or 1.5 to 4% by weight, and very particularly preferably from 1.5 to 2% by weight, based on the sum of the weights of zeolite and palladium and calculated as palladium metal. In embodiments of the present invention, coating zone A does not include platinum.

Coating zone B comprises the same components as coating zone A, preferably also in the same amounts as coating zone A. In particular, coating zone B also comprises the same zeolites as coating zone A and palladium, preferably also in the same amounts as coating zone A. If coating zone A in addition to zeolite, palladium and optionally platinum (see below) comprises further components; these will preferably also be present in coating zone B in the same amounts.

In addition, coating zone B also comprises platinum, preferably in amounts from 0.1 to 20% by weight, particularly preferably in amounts from 2.5 to 15% by weight, and very particularly preferably in amounts from 5 to 10% by weight, in each case based on the weight of the palladium in coating zone B and calculated as platinum metal.

In preferred embodiments of the present invention, coating zone A does not contain platinum. However, the present invention also encompasses embodiments in which the coating zone A already contains platinum. In this case, coating zone B contains a larger amount (% by weight) of platinum than coating zone B. In all embodiments, the coating zones A and B are not identical, but differ.

Like palladium, platinum is also preferably present as a cation in the zeolite structure, that is to say in ion-exchanged form, but may also be present wholly or partially as metal and/or as oxide in the zeolite structure and/or on the surface of the zeolite structure. In addition, platinum may also be supported on other components which may be present in coating zone B.

In a preferred embodiment, coating zones A and B comprise a coating zone with 0.5 to 3% by weight of palladium, based on the sum of the weights of zeolite and palladium and calculated as palladium metal, in particular ion-exchanged zeolites of the structure type ABW, AEI, AFX, BEA, CHA, ERI, ESV, FAU, FER, KFI, LEV, LTA, MFI, SOD or STT, and coating zone B additionally comprises 0.5 to 1.5% by weight of palladium, based on the weight of the palladium in coating zone B and calculated as platinum metal.

The catalyst according to the invention comprises a support body. This may be a flow-through substrate or a wall-flow filter.

A wall-flow filter is a support body comprising channels of length L, which extend in parallel between first and second ends of the wall flow filter, which are alternately closed at either the first or second end and are separated by porous walls. A flow-through substrate differs from a wall-flow filter in particular in that the channels of length L are open at both ends. In an uncoated state, wall-flow filters have, for example, porosities of 30 to 80%, in particular 50 to 75%. In the uncoated state, their average pore size is 5 to 30 micrometers, for example. Generally, the pores of the wall-flow filter are so-called open pores, that is, they have a connection to the channels. Furthermore, the pores are normally interconnected with one another. This enables, on the one hand, the easy coating of the inner pore surfaces and, on the other hand, the easy passage of the exhaust gas through the porous walls of the wall-flow filter.

Like wall-flow filters, flow-through substrates are known to the person skilled in the art and are available on the market. They consist, for example, of silicon carbide, aluminum titanate, or cordierite.

The catalyst according to the invention in one embodiment does not contain any other metal, in particular neither copper nor iron, other than palladium and platinum.

In the case of a wall-flow filter, the coating zones A and B may be located on the surfaces of the input channels, on the surfaces of the output channels and/or in the porous wall between the input and output channels.

The catalysts according to the invention can be produced by methods familiar to the person skilled in the art, for example by the common dip-coating method or pump-coating and suction-coating methods with subsequent thermal aftertreatment (calcination). Here in one variant, coating zone A is coated from one end of the carrier substrate to length L_{A} and in another step coating zone B is coated from the other end of the carrier substrate to length L_{B}. In another preferred variant, in a first step, a washcoat, which corresponds in terms of its composition to coating zone A, is applied over the entire length L of the carrier substrate. Subsequently, in a second step, the coated carrier substrate is impregnated with an aqueous solution of a platinum compound starting from its end b to the length L_{B}. The impregnation can be effected in a simple manner by immersing the coated carrier substrate in a suitable aqueous solution of a platinum compound. A suitable water-soluble platinum compound is in particular platinum nitrate.

The person skilled in the art is aware that, in the case of wall-flow filters, their average pore size and the average particle size of the materials to be coated can be matched to each other in such a manner that they lie on the porous walls that form the channels of the wall-flow filter (on-wall coating). The mean particle size of the materials to be coated can also be selected such that they are located in the porous walls that form the channels of the wall-flow filter; i.e., that the inner pore surfaces are coated (in-wall coating). In this case, the average particle size of the coating materials must be small enough to penetrate into the pores of the wall-flow filter.

The coating zones A and B are preferably present in an amount from 50 to 250 g/l carrier substrate.

In one embodiment of the present invention, the carrier substrate is formed from the zeolite and palladium, as well as a matrix component, and coating zone B is impregnated over the length L_{B} onto this carrier substrate. Carrier substrates, flow-through substrates and wall-flow substrates that do not just consist of inert material, such as cordierite, but additionally contain a catalytically active material are known to the person skilled in the art. To produce them, a mixture consisting of, for example, 10 to 95% by weight of an inert matrix component and 5 to 90% by weight of catalytically active material is extruded according to a method known per se. All of the inert materials that are also otherwise used to produce catalyst substrates can be used as matrix components in this case. These are, for example, silicates, oxides, nitrides, or carbides, wherein in particular magnesium aluminum silicates are preferred.

The catalyst according to the invention is excellently suited as a passive nitrogen oxide storage catalyst; i.e., it can take into storage nitrogen oxides at temperatures below 200° C. and take them out of storage again at temperatures above 200° C., It is, therefore, possible, in combination with a downstream SCR catalyst, to effectively convert nitrogen oxides across the entire temperature range of the exhaust gas, including the cold-start temperatures.

The present invention also relates to a method for purifying the exhaust gases of motor vehicles which are operated with lean-burn engines, such as diesel engines, characterized in that the exhaust gas is passed through an exhaust gas system according to the invention. In one embodiment of the method according to the invention, exhaust gas enters the carrier substrate at carrier substrate end a and leaves it again at carrier substrate end b. In another embodiment of the method according to the invention, exhaust gas enters the carrier substrate at carrier substrate end b and leaves it again at carrier substrate end a.

The present invention therefore relates to an exhaust gas system comprising a) a catalyst which comprises a carrier substrate of length L, which extends between two carrier substrate ends a and b and comprises two coating zones A and B, wherein coating zone A comprises a zeolite and palladium and extends from carrier substrate end a along a part of length L, coating zone B comprises the same components as coating zone A and platinum and extends starting from carrier substrate end b on a part of length L, wherein L L_{A}+L_{B} applies, wherein L_{A} is the length of the coating zone A and L_{B} is the length of the coating zone B, and b) an SCR catalyst.

In the exhaust gas system according to the invention, the SCR catalyst may in principle be selected from all catalysts active in the SCR reaction of nitrogen oxides with ammonia, in particular from those known as being conventional to the person skilled in the art in the field of automotive exhaust gas catalysis. This includes catalysts of the mixed oxide type along with catalysts based on zeolites, in particular transition-metal-exchanged zeolites, for example zeolites exchanged with copper, iron or copper and iron.

In embodiments of the present invention, SCR catalysts that are a small-pored zeolite with a maximum ring size of eight tetrahedral atoms and a transition metal, for example copper, iron or copper and iron, are used, Such SCR catalysts are described for example in WO2008/106519 A1, WO2008/118434 A1 and WO2008/132452 A2. In addition, large-pored and medium-pored zeolites can also be used, with those of the BEA structure type in particular coming into question. Thus, iron-BEA and copper-BEA are of interest.

Particularly preferred zeolites belong to the scaffold types BEA, AEI, CHA, KFI, ERI, LEV, MER or DDR and are particularly preferably exchanged with copper, iron or copper and iron,

The term zeolites within the context of the present invention also includes molecular sieves, which are sometimes also referred to as “zeolite-like” compounds. Molecular sieves are preferred, if they belong to one of the aforementioned structure types. Examples include silica aluminum phosphate zeolites, which are known by the term SAPO, and aluminum phosphate zeolites, which are known by the term AlPO. These are also preferred in particular if they are exchanged with copper, iron or copper and iron.

Preferred zeolites continue to be those that have a SAR (silica-to-alumina ratio) value of 2 to 100, in particular of 5 to 50.

The zeolites or molecular sieves contain transition metal—in particular, in quantities of 1 to 10 wt %, and especially 2 to 5 wt % calculated as metal oxide, i.e., for example, as Fe₂O₃ or CuO.

Preferred embodiments of the present invention contain zeolites or molecular sieves of the beta type (BEA), chabazite type (CHA) or Levyne type (LEV) exchanged as SCR catalysts with copper, iron or copper and iron. Corresponding zeolites or molecular sieves are known, for example, under the designations ZSM-5, Beta, SSZ-13, SSZ-62, Nu-3, ZK-20, LZ-132, SAPO-34, SAPO-35, AlPO-34 and AlPO-35; see, for example, U.S. Pat. Nos. 6,709,644 and 8,617,474.

In one embodiment of the exhaust gas system according to the invention, an injecting device for reducing agent is located between the catalytic converter according to the invention and the SCR catalytic converter. The injection device can be chosen freely by the person skilled in the art, wherein suitable devices can be taken from the literature (see, for example, T. Mayer, Feststoff-SCR-System auf Basis von Ammoniumcarbamat, dissertation, T U Kaiserslautern, 2005). The ammonia can be injected into the exhaust gas stream via the injection device as such or in the form of a compound from which ammonia is formed under ambient conditions. Examples of suitable compounds are aqueous solutions of urea or ammonium formate, as well as solid ammonium carbamate. As a rule, the reducing agent or precursor thereof is held available in an accompanying container which is connected to the injection device.

The SCR catalyst is preferably in the form of a coating on a support body, which can be a flow substrate or a wall-flow filter and can consist of silicon carbide, aluminum titanate or cordierite, for example. Alternatively, the support body itself can consist of the SCR catalyst and a matrix component as described above; i.e., in extruded form.

The present invention also relates to a method for purifying the exhaust gases of motor vehicles which are operated with lean-burn engines, such as diesel engines, characterized in that the exhaust gas is passed through an exhaust gas system according to the invention. In one embodiment of the method according to the invention, exhaust gas enters the carrier substrate at carrier substrate end a, leaves it again at carrier substrate end b and then enters the SCR catalytic converter. In another embodiment of the method according to the invention, exhaust gas enters the carrier substrate at carrier substrate end b, leaves it again at carrier substrate end a and then enters the SCR catalytic converter.

### COMPARATIVE EXAMPLE 1

a) A zeolite of structure type FER is impregnated with 3% by weight of palladium (from commercially available palladium nitrate) (“incipient wetness”). The powder thus obtained is then dried in stages at 120 and 350° C. and calcined at 500° C.

b) The resulting calcined powder containing Pd is suspended in demineralized water, mixed with 8% of a commercially available binder based on boehmite and ground in a ball mill. Subsequently, according to a conventional method, a commercially available honeycomb ceramic substrate (flow-through substrate) is coated along its entire length with the washcoat thus obtained. The washcoat load is 100 g/L, based on the Pd-containing zeolites (corresponding to 108 g/L incl. binder), which corresponds to a palladium load of 85 g/ft³ Pd. Finally, calcination takes place at 550° C. The catalyst is referred to below as VK1.

### COMPARATIVE EXAMPLE 2

The catalyst obtained from comparative example 1 is impregnated with a Pt-nitrate solution over the entire length L in such a way that the quantity of platinum applied corresponds to 10% by weight of the quantity of palladium applied in comparative example 1. The platinum load is thus 8.5 g/ft³ Pt. Finally, calcination takes place at 550° C. The catalyst is referred to below as VK2.

### EXAMPLE 1

Comparative example 2 is repeated with the difference that the amount of platinum applied, which in this case is only 8.8% by weight of the amount of palladium applied in comparative example 1, is only impregnated over 50% of the length L from the entrance. The platinum load is thus 7.48 g/ft³. Finally, the mixture is calcined at 550° C. The catalyst is referred to below as K1.

### Testing

a) The catalysts VK1, VK2 and K1 were hydrothermally aged for 16 hours at a temperature of 650° C. b) They were then subjected to a NOx storage test with a temperature-programmed desorption (TPD). This took place in a suitable model gas reactor using a so-called “drill core” with the dimensions 1″×3″ (diameter x length) and a cell size of 400 cpsi as well as a wall thickness of 4.3 mil. Two different gas compositions are used in the course of the test: At a space velocity of 30 000 1/h, 200 ppm nitrogen oxide, 200 ppm carbon monoxide and 50 ppm n-decane (as C10, corresponding to 500 ppm as C1) are present, as well as the gases oxygen in 12% by volume and water in 10% by volume. At the beginning of the measurement, the aforementioned gas mixture is switched to “bypass” for a period of 2 minutes at a temperature of 100° C. After the 2 minutes have elapsed, the aforementioned gas mixture is passed over the drill core, wherein the temperature is kept constant at 100° C. for 10 minutes, before the exhaust gas is then heated with a heating ramp of 15° C./min. Once the desired final temperature of 600° C. has been reached, this is maintained for a further 10 minutes, in order to ensure the complete emptying of the drilling core.

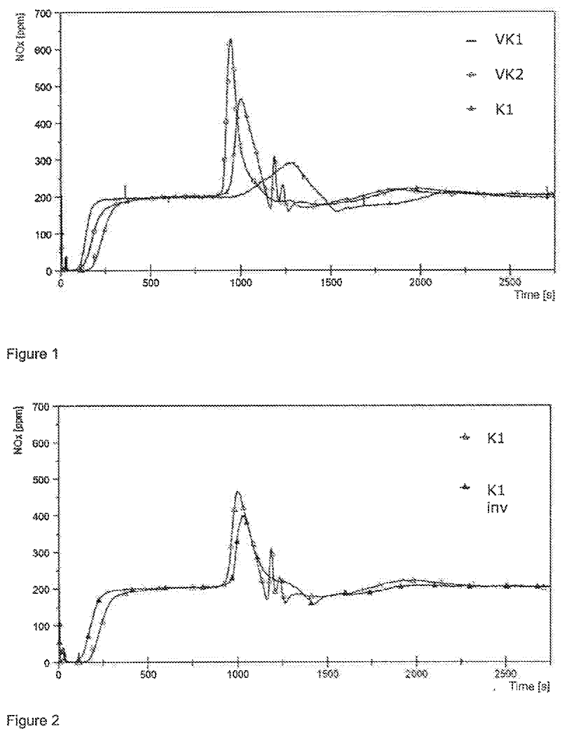

The results are shown in FIG. 1. This shows the NOx emissions after the catalyst. According to FIG. 1, catalysts VK1 and VK2 store nitrogen oxide almost identically at 100° C. (storage phase), whereas catalyst K1 has the highest storage capacity by far. The stored amount of nitrogen oxide is described by the area enclosed by the y axis, a line parallel to the y axis with y=200, and the measured curve. In the desorption phase, it is found that all catalysts desorb the full amount of the adsorbed nitrogen oxide after 1500 seconds at the latest.

FIG. 2 shows the repetition of the above-described experiment with catalyst K1 in different installation directions, Catalyst K1 was once introduced with the Pt-containing zone upstream in the model gas reactor (K1 in FIG. 2); at another time with the Pt-containing zone downstream (K1 inv in FIG. 2). In the upstream case (K1), the nitrogen oxide storage capacity is higher and its desorption is later (that is, at higher temperatures). In the downstream case (K1 inv), the nitrogen oxide storage capacity is lower and its desorption takes place earlier (that is, at lower temperatures).

1. Catalyst comprising a carrier substrate of length L, which extends between two carrier substrate ends a and b and comprises two coating zones A and B, wherein
coating zone A comprises a zeolite and palladium and extends from carrier substrate end a along a part of length L,
coating zone B comprises the same components as coating zone A and platinum and extends starting from carrier substrate end b along a part of length L, wherein
L=L_{A}+L_{B} applies, wherein L_{A} is the length of the coating zone A and L_{B} is the length of the coating zone B.

2. Catalyst according to claim 1, characterized in that the largest channels of the zeolite are formed by 6 tetrahedrally coordinated atoms and the zeolite belongs to structure types AFG, AST, DOH, FAR, FRA, GIU, LIO, LOS, MAR, MEP, MSO, MTN, NON, RUT, SGT, SOD, SVV, TOL or UOZ.

3. Catalyst according to claim 1, characterized in that the largest channels of the zeolite are formed by 8 tetrahedrally coordinated atoms and the zeolite belongs to structure types ABW, ACO, AEI, AEN, AFN, AFT, AFV, AFX, ANA, APC, APD, ATN, ATT, ATV, AVL, AWO, AW, BCT, BIK, BRE, CAS, CDO, CHA, DDR, DFT, EAB, EDI, EEI, EPI, ERI, ESV, ETL, GIS, GOO, IFY, IHW, IRN, ITE, ITW, JBW, JNT, JOZ, JSN, JSW, KFI, LEV, -LIT, LTA, LTJ, LTN, MER, MON, MTF, MWF, NPT, NSI, OWE, PAU, PHI, RHO, RTH, RWR, SAS, SAT, SAV, SBN, SIV, THO, TSC, UEI, UFI, VNI, YUG or ZON.

4. Catalyst according to claim 1, characterized in that the largest channels of the zeolite are formed by 9 tetrahedrally coordinated atoms and the zeolite belongs to structure types -CHI, LOV, NAB, NAT, RSN, STT or VSV.

5. Catalyst according to claim 1, characterized in that the largest channels of the zeolite are formed by 10 tetrahedrally coordinated atoms and the zeolite belongs to structure types FER, MEL, MFI, MTT, MWW or SZR.

6. Catalyst according to claim 1, characterized in that the largest channels of the zeolite are formed by 12 tetrahedrally coordinated atoms and the zeolite belongs to structure types AFI, AFR, AFS, AFY, ASV, ATO, ATS, BEA, BEC, BOG, BPH, CAN, CON, CZP, DFO, EMT, EON, EZT, FAU, GME, GON, IFR, ISV, IWR, IWV, IWW, LTL, MAZ, MEI, MOR, MOZ, MSE, MTW, NPO, OFF, OSI, -RON, RWY, SAO, SBE, SBS, SBT, SFE, SFO, SOS, SSY, USI or VET.

7. Catalyst according to claim 1, characterized in that the zeolite belongs to structure types ABW, AEI, AFX, BEA, CHA, ERI, ESV, FAU, FER, KFI, LEV, LTA, MFI, SOD or STT.

8. Catalyst according to claim 1, characterized in that the palladium and the platinum are present as a cation in the zeolite structure.

9. Catalyst according to claim 1, characterized in that coating zones A and B have a weight of 0.5 to 3% by weight of palladium, based on the sum of the weights of zeolite and palladium and calculated as palladium metal, comprise coated, ionically exchanged zeolites of the structure type ABW, AEI, AFX, BEA, CHA, ERI, ESV, FAU, fer, KFI, LEV, LTA, MFI, SOD or STT, and coating zone B additionally comprises 5 to 10% by weight of platinum, based on the weight of the palladium in coating zone B and calculated as platinum metal.

10. Catalyst according to claim 1, characterized in that coating zone B contains the same components in the same amounts as coating zone A, and platinum.

11. Catalyst according to claim 1, characterized in that coating zone A contains no platinum.

12. Catalyst according to claim 1, characterized in that coating zones A and B are not identical.

13. Exhaust gas system comprising
a) a catalyst which comprises a carrier substrate of length L, which extends between two carrier substrate ends a and b and comprises two coating zones A and B, wherein
coating zone A comprises a zeolite and palladium and extends from carrier substrate end a along a part of length L,
coating zone B comprises the same components as coating zone A and platinum and extends starting from carrier substrate end b along a part of length L, wherein
L=L_{A}+L_{B} applies, wherein L_{A} is the length of the coating zone A and L_{B} is the length of the
coating zone B.
and
b) an SCR catalyst

14. Exhaust gas system according to claim 13, characterized in that the SCR catalyst is a zeolite belonging to the scaffold type BEA, AEI, CHA, KFI, ERI, LEV, MER or DDR and is exchanged with copper, iron or copper and iron.

15. Method for purifying the exhaust gases of motor vehicles operated with lean-burn engines, characterized in that the exhaust gas is passed through an exhaust gas system according to claim 14.
